(19) United States
(12) Patent Application Publication
(10) Pub. No.: US 2014/0107291 A1
(43) Pub. Date: Apr. 17, 2014

(54) MOULDED PARTS CONSISTING OF REINFORCED POLYURETHANE UREA ELASTOMERS AND USE THEREOF

(71) Applicants: Norbert Eisen, Koln (DE); Stephan Reiter, Langenfeld (DE); Dieter Gaumitz, Kerpen (DE)

(72) Inventors: Norbert Eisen, Koln (DE); Stephan Reiter, Langenfeld (DE); Dieter Gaumitz, Kerpen (DE)

(73) Assignee: BAYER INTELLECTUAL PROPERTY GmbH, Monheim (DE)

(21) Appl. No.: 14/007,215

(22) PCT Filed: Mar. 21, 2012
(86) PCT No.: PCT/EP2012/054968

§ 371 Date: Dec. 23, 2013

(30) Foreign Application Priority Data
Mar. 24, 2011 (DE) 10 2011 006 051.0

(51) Int. Cl. C08K 7/28

(52) U.S. Cl. CPC C08K 7/28
USPC 524/847

(57) ABSTRACT

The invention relates to moulded parts provided with reinforcing materials and consisting of polyurethane urea elastomers having defined urea and urethane contents, and to the use thereof.

The invention relates to moldings equipped with reinforcing materials and made of polyurethaneurea elastomers with particular contents of urea and of urethane, and also to use of these.

The production of polyurethaneurea elastomers via reaction of NCO semiprepolymers with mixtures of aromatic diamines, and also relatively high-molecular-weight compounds comprising hydroxy or amino groups is known and is described by way of example in EP-A 225 640. In order to achieve particular mechanical properties in the resultant moldings, reinforcing materials have to be added to the reaction components, giving in particular improved thermomechanical properties and a considerable increase in flexural modulus of elasticity. However, the use of said reinforcing materials also changes the longitudinal and transverse shrinkage properties of the moldings produced.

It is therefore desirable that reinforced polyurethaneurea elastomers used in the production of sheet-like moldings such as wheel surrounds, doors, or tailgates of automobiles, exhibit approximately isotropic behavior, i.e. minimal differences in longitudinal and transverse shrinkage properties.

The moldings produced from the reinforced polyurethane elastomers are moreover intended to have low weight and to require minimal addition of mold-release agents for separation from the molds, thus reliably providing an easy-separation system that gives maximal cycle times.

In EP-A 1004 606, good separation properties of the reinforced PU-urea elastomers were obtained by increasing the functionality of the polyol reaction component to from 4 to 8 and the functionality of the polyol component used in the production of the isocyanate prepolymer component to from 3 to 8.

When contents of polyurea segments in the elastomer are high (starting at from 85 to 90 mol %, based on mol % of an NCO equivalent), the elastomer exhibits severe embrittlement. These moldings fracture easily when subjected to flexural stress.

A specific factor of continuously increasing importance in the automobile industry is weight saving. When a molding involves polyurethane urea elastomers, its density and therefore its weight can be controlled within a certain range via the amount of the reaction mixture introduced into the mold. However, the moldings generally involve microcellular elastomers, i.e. do not involve genuine foams with a foam structure visible to the naked eye. This means that the function of any organic blowing agents used concomitantly is that of a flow promoter rather than that of a genuine blowing agent. In principle, it is possible to achieve a significant density reduction by increasing blowing agent content and introducing less material into the mold. However, this is not a useful way of achieving a significant weight reduction in practice, since even a small increase in the extent of incipient foaming of the microcellular elastomers specifically causes a decrease in the flexural modulus of elasticity to a level that is no longer acceptable.

The density of the resultant moldings is also, of course, greatly dependent on the nature of, and the proportion by weight of, the filler materials concomitantly used. EP-A 0 639 614 says that a density reduction can be achieved by the use of hollow microspheres made of glass or ceramic. Relevant factors here are not only the comparatively low density of the hollow microspheres themselves but also the ability of the microspheres to permit higher gas loading of the polyol (A component), giving a higher degree of foaming. Although mineral fibers are also used as reinforcing materials in addition to the hollow microspheres, the disadvantage of said process is that it is only possible to produce moldings with relatively low flexural moduli of elasticity. Numerous examples are adduced, the highest flexural modulus of elasticity achieved being 486 MPa. However, values of at least 600 MPa, indeed in certain applications 1000 MPa, are essential for bodywork components in the automobile industry. EP-A 0 639 614 mentions various reinforcing materials such as glass fibers or glass flakes, mica, wollastonite, carbon black, talc powder, calcium carbonate, and carbon fibers. However, there is no indication of any method that can achieve markedly higher flexural moduli of elasticity without any attendant requirement for significant density increase.

EP-A 0 267 603 describes the use of relatively small amounts of carbon fibers as reinforcing material to obtain polyurethaneurea elastomers having properties comparable with those of elastomers reinforced with markedly greater amounts of glass fibers. The average fiber length of the carbon fibers used in that document is from 0.3 to 0.4 mm. However, it has been found in practice that fibrous fillers with fiber lengths greater than 0.2 mm are extremely difficult to process. A specific problem here is that the nozzles used in the RIM process are susceptible to blockage, and this causes extreme pressure variations at the high-pressure mixing heads, and therefore variation in mixing quality of what are known as A component and B component. There is therefore insufficient process reliability during continuous production, whereas this is essential specifically for conveyor-belt production in the automobile industry.

It was therefore an object to provide moldings which have good thermomechanical properties, significantly lower density than familiar polyurethaneurea elastomers, a flexural modulus of elasticity of at least 600 MPa, low anisotropy, good separation properties, and low operating times. In order to ensure process reliability, use of fibrous reinforcing materials with average fiber length greater than 0.2 mm is not permitted.

Surprisingly, this object was achieved by a specifically constituted polyurethaneurea elastomer with specific hollow microspheres and carbon fibers of a specific length.

The present invention therefore provides polyurethaneurea elastomers equipped with reinforcing materials and with from 70 to 95 mol % urea content and from 5 to 30 mol % urethane content, based in each case on mol % of an NCO equivalent, obtainable via reaction of a reaction mixture made of an

A component made of
A1) aromatic diamines which at least have an alkyl substituent in each case in an ortho-position with respect to the amino groups,
A2) at least one aliphatic component composed of at least one polyether polyol and/or polyester polyol which respectively has hydroxy and/or primary amino groups and which has a number-average molecular weight of from 500 to 18 000 and a functionality of from 3 to 8, and
A3) optionally catalysts and/or optionally additives,
   and also of, as B component, prepolymer which comprises isocyanate groups and which derives from the reaction of
B1) a polyisocyanate component from the group consisting of polyisocyanates and polyisocyanate mixtures of the diphenylmethane category and liquefied polyisocyanates of the diphenylmethane category with
B2) at least one polyol component with a number-average molecular weight of from 500 to 18 000 and with a functionality of from 2.7 to 8 from the group consisting of polyether polyols optionally comprising organic fillers and polyester polyols optionally comprising organic fillers,
   characterized in that component A and/or component B comprises hollow rigid microspheres (C) and carbon fibers (D).

The hollow rigid microspheres (C) significantly reduce the density of the polyurethaneurea elastomers, and there is no need here for any higher level of foaming with the disadvantages mentioned associated therewith. The carbon fibers (D) achieve the required thermomechanical properties, and in particular the necessary flexural modulus of elasticity. The moldings of the invention, produced with the carbon fibers, have lower density, for the same flexural modulus of elasticity, than moldings produced with glass fibers or with mineral fibers.

The ordinary person skilled in the art is aware that because fibrous reinforcing materials have orientation in the direction of flow of the reaction mixture they lead to anisotropic shrinkage behavior of the moldings, i.e. differences in shrinkage along and perpendicularly to the direction of flow, and thus to the direction of the fibers. Other findings when fibrous reinforcing materials are used are accordingly differences in the magnitude of coefficients of linear thermal expansion, and also in flexural moduli of elasticity along and perpendicularly to the direction of the fibers. Highly anisotropic shrinkage behavior can lead to warpage of the moldings after production, and highly anisotropic linear thermal expansion can lead to warpage of the moldings at higher service temperatures. Both are undesirable, and minimal anisotropy is therefore always desirable.

If hollow rigid microspheres are used together with a mineral fiber such as Tremin 939-304 (wollastonite, Quarzwerke Frechen), a significant difference in longitudinal and transverse shrinkage is found, as expected. Surprisingly, the extent of this anisotropic shrinkage behavior is much less when hollow rigid microspheres are used in the invention together with carbon fibers, and this represents an enormous advantage specifically in respect of the warpage problems of sheet-like moldings.

The relative amounts reacted of the A component and the B component are such that the isocyanate index of the resultant elastomer is preferably in the range from 80 to 120, and the polyol component B2) introduced by way of the B component represents from 10 to 90 mol % of the urethane content.

It is preferable to use reinforced polyurethane elastomers with from 75 to 90 mol % urea content and with from 10 to 25 mol % urethane content, based on mol % of an NCO equivalent.

It is moreover preferable that the relative amounts reacted of the A component and the B component are such that the isocyanate index of the resultant elastomer is preferably in the range from 90 to 115, and the polyol component B2) introduced by way of the B component represents from 30 to 85 mol % of the urethane content.

Carbon fibers (D) (C fibers) used can by way of example comprise the ground carbon fiber grades Sigrafil® C10 M250 UNS, and Sigrafil® C30 M150 UNS from SGL Carbon, or Tenax®-A HT M100 100mu, and Tenax®-A HT M100 60mu from Toho Tenax Europe GmbH, or CFMP-150 90 μm from NIPPON POLYMER SANGYO CO., LTD., obtainable from Dreychem. Preference is given to carbon fibers where the average length of the fibers is from 60 to 200 μm, particularly from 90 to 200 μm, in particular from 90 to 150 μm.

The usual amounts used of the carbon fibers in the molding of the invention are from 1 to 20% by weight, preferably from 1 to 15% by weight, particularly preferably from 1 to 10% by weight, and with particular preference from 3 to 7% by weight, based on the total amount of components A, B, C, and D.

As described above, what is known as an A component is reacted with what is known as a B component, where the A component preferably comprises the carbon fibers (D).

Component (C) used in the invention comprises rigid hollow microspheres (microballoons, microbubbles) whose resistance to heat and pressure is sufficient for processing by the RIM process. Suitable rigid hollow microspheres can be composed of inorganic materials such as glass, ceramic, and carbon, or of rigid, organic polymers such as phenolic resins. Hollow inorganic microspheres can be produced by known processes. The production of hollow glass spheres is described by way of example in U.S. Pat. No. 3,365,315 and U.S. Pat. No. 2,978,339.

Ceramic hollow microspheres are generally heavier than hollow glass spheres of comparable size. Preference is therefore given to hollow glass microspheres in the present invention. Hollow glass spheres that are preferred are those with densities of from 0.05 to 0.8 g/cm³, particularly from 0.1 to 0.7 g/cm³, very particularly from 0.3 to 0.7 g/cm³, in particular 0.6 g/cm³.

Examples of hollow inorganic microspheres available commercially are ceramic Z-Light Spheres, and 3M™ Glass Bubbles™ K46, S60, S60HS, and iM30K from 3M. Commercially available hollow glass spheres typically comprise about 72% by weight of SiO₂, 14% by weight of Na₂O, 10% by weight of CaO, 3% by weight of MgO, and 1% by weight of Al₂O₃/K₂O/Li₂O. Ceramic hollow microspheres in contrast typically comprise about 50-58% by weight of SiO₂, 25-30% by weight of Al₂O₃, 6-10% by weight of CaO, 1-4% by weight of Na₂O/K₂O, and 1-5% by weight of other oxides. Further information is found in J. F. Plummer, “Microspheres” in Encyclopedia of Polymer Science and Technology, Vol. 9 (John Wiley & Sons, Inc., 1987), page 788.

Any particular grade of hollow microspheres is typically composed of a certain range of sizes, another term used being a size distribution. Microspheres suitable for the present invention typically have a diameter of from about 9 to about 120 μm, preferably 9-65 μm, particularly preferably 9-30 μm. The ideal size range of the microspheres in a particular case also depends on the machine parameters prevailing during processing by the RIM process, for example the nozzle diameter.

The hollow glass microspheres can be added not only to the A component but also to the B component, preference being given here to addition to the A component. The amount added of the microspheres is such that the microsphere content of the finished product is from 0.5 to 40% by weight, preferably 2-30% by weight, particularly preferably 5-20% by weight, and with particular preference 5-15% by weight.

Materials that can be used as component A1) are aromatic diamines which at least have an alkyl substituent in each case in an ortho-position with respect to the amino groups, and which have a molecular weight of from 122 to 400. Particular preference is given to those aromatic diamines which have at least one alkyl substituent in ortho-position with respect to the first amino group, and which, in ortho-position with respect to the second amino group, have two alkyl substituents having in each case from 1 to 4, preferably from 1 to 3, carbon atoms. Very particular preference is given to those which have an ethyl, n-propyl, and/or isopropyl substituent in each case in at least one ortho-position with respect to the amino groups, and optionally methyl substituents in further ortho-positions with respect to the amino groups. Examples of diamines of this type are 2,4-diaminomesitylene, 1,3,5-triethyl-2,4-diaminobenzene, and also its technical mixtures with 1-methyl-3,5-diethyl-2,6-diaminobenzene or 3,5,3′,5′-tetraisopropyl-4,4′-diaminodiphenylmethane. It is, of course, equally possible to use the mixtures of the materials with one another. It is particularly preferable that component A1) involves 1-methyl-3,5-diethyl-2,4-diaminobenzene or its technical mixtures with 1-methyl-3,5-diethyl-2,6-diaminobenzene (DETDA).

Component A2) is composed of at least one aliphatic polyether polyol or polyester polyol which respectively has hydroxy and/or primary amino groups and which has a molecular weight of from 500 to 18 000, preferably from 1000 to 16 000, with preference from 1500 to 15 000. Component A2) has the abovementioned functionalities. The polyether polyols can be produced in a manner known per se via alkoxylation of starter molecules or of their mixtures of appropriate functionality, and the alkoxylation process here in particular uses propylene oxide and ethylene oxide. Suitable starters or starter mixtures are sucrose, sorbitol, pentaerythritol, glycerol, trimethylolpropane, propylene glycol, and also water. Preference is given to those polyether polyols whose hydroxy groups are composed of at least 50%, preferably at least 70%, in particular exclusively of primary hydroxy groups.

Polyester polyols that can be used are in particular those composed of the dicarboxylic acids known for this purpose, for example adipic acid and phthalic acid, and of polyhydric alcohols such as ethylene glycol and 1,4-butanediol, optionally with a proportion of glycerol and trimethylolpropane.

These polyether polyols and polyester polyols are described by way of example in Kunststoffhandbuch [Plastics Handbook] 7, Becker/Braun, Carl Hanser Verlag, 3^{rd} edition, 1993.

Other materials that can be used as component A2) are polyether polyols and/or polyester polyols respectively having primary amino groups, for example those described in EP-A 219 035 and those known as ATPE (amino-terminated polyethers).

Particularly suitable polyether polyols and/or polyester polyols respectively having amino groups are those known as Jeffamine® from Huntsman, these being composed of α,ω-diamino-polypropylene glycols.

Materials that can be used as component A3) are the known catalysts for the urethane and urea reaction, for example tertiary amines, or the tin (II) or tin (IV) salts of higher carboxylic acids. Other additives that can be used are stabilizers, such as the known polyethersiloxanes or release agents such as zinc stearate. The known catalysts or additives are described by way of example in chapter 3.4 of Kunststoffhandbuch J. Polyurethane [Plastics handbook J. Polyurethanes], Carl Hanser Verlag (1993), pp. 95 to 119, and the usual amounts of these can be used.

What is known as the B component is an NCO prepolymer based on the polyisocyanate component B1) and on the polyol component B2), and has from 8 to 32% by weight NCO content, preferably from 12 to 26% by weight, particularly preferably from 12 to 25% by weight, more preferably from 14 to 25% by weight, with particular preference from 14 to 20% by weight.

The polyisocyanates B1) involve polyisocyanates or polyisocyanate mixtures of the diphenylmethane category, where these have optionally been liquefied by chemical modification. The expression “polyisocyanate of the diphenylmethane category” is the generic expression for all of the polyisocyanates that are formed during the phosgenation of aniline/formaldehyde condensates and that are present as individual components in the phosgenation products. The expression “polyisocyanate mixture of the diphenylmethane category” means any desired mixture of polyisocyanates of the diphenylmethane category, i.e. by way of example the phosgenation products mentioned, the mixtures arising as distillate or distillation residue during the distillative separation of such mixtures, and any desired blend of polyisocyanates of the diphenylmethane category.

Typical examples of suitable polyisocyanates B1) are 4,4′-diisocyanatodiphenylmethane, its mixtures with 2,2′- and in particular 2,4′-diisocyanatodiphenylmethane, mixtures of these diisocyanatodiphenylmethane isomers with their higher homologs arising during the phosgenation of aniline/formaldehyde condensates via partial carbodiimidization of the isocyanate groups of the di- and/or polyisocyanates mentioned; other examples are modified di- and/or polyisocyanates and any desired mixtures of such polyisocyanates.

Materials particularly suitable as component B2) are the polyether polyols and polyester polyols complying with this definition, and mixtures of polyhydroxy compounds of this type. Examples of materials that can be used are corresponding polyether polyols which optionally comprise organic fillers in dispersed form. These dispersed fillers involve by way of example vinyl polymers produced by way of example via polymerization of acrylonitrile and styrene in the polyether polyols as reaction medium (US Patent Specifications 33 83 351, 33 04 273, 35 23 093, 31 10 695, German Patent Specification 11 52 536), or involve polyureas or polyhydrazides produced via a polyaddition reaction in the polyether polyols as reaction medium, from organic diisocyanates and diamines and, respectively, hydrazine (German Patent Specification 12 60 142, DE-OS (German Published Specification) 24 23 984, 25 19 004, 25 13 815, 25 50 833, 25 50 862, 26 33 293, or 25 50 796). In principle, polyether polyols or polyester polyols of the type already mentioned above under A2) are suitable as component B2), as long as they comply with the parameters mentioned immediately above.

The average molecular weight of the polyol component B2) is preferably from 1000 to 16 000, in particular from 2000 to 16 000, with an average hydroxy functionality of from 2.7 to 8, preferably from 2.7 to 7.

For the production of the NCO semiprepolymers B) it is preferable to react the components B1) and B2) in quantitative ratios (NCO excess) such that NCO semiprepolymers with the abovementioned NCO content result. The relevant reaction generally takes place within the temperature range from 25 to 100° C. In the production of the NCO semiprepolymers it is preferable to react the entire amount of the polyisocyanate component B1) with preferably the entire amount of the component B2) provided for the production of the NCO semiprepolymers.

The elastomers of the invention are produced by the known reaction injection molding technique (“RIM process”) as described by way of example in DE-AS (German Published Specification) 2 622 951 (U.S. Pat. No. 4,218,543) or DE-OS (German Published Specification) 39 14 718. The relative amounts of components A and B here correspond to the stoichiometric ratios with an NCO index of from 80 to 120. The moldings of the invention generally involve microcellular elastomers, i.e. do not involve genuine foams in which the foam structure is discernible by the naked eye. This means that the function of any organic blowing agents used concomitantly is that of a flow promoter rather than that of a genuine blowing agent.

The amount of the reaction mixture introduced into the mold is judged so as to give the molding a density of from 0.7 to 1.1 g/cm³, preferably from 0.8 to 1.1 g/cm³, particularly preferably from 0.9 to 1.1 g/cm³, and with particular preference from 0.9 to 1.0 g/cm³.

The constitution of the polyurethaneurea elastomer (components A and B) and the contents of hollow rigid microspheres and carbon fibers are selected so as to give the reinforced elastomer a flexural modulus of elasticity of at least 600 MPa along the direction of the fibers, preferably at least 700 MPa, particularly preferably at least 800 MPa, very particularly preferably at least 900 MPa, and with particular preference at least 1000 MPa.

The initial temperature of the reaction mixture introduced into the mold and made of the components A) and B) is generally from 20 to 80° C., preferably from 30 to 70° C. The temperature of the mold is generally from 30 to 130° C., preferably from 40 to 80° C. The molds used generally involve those of the type known per se, preferably made of aluminum or steel, or involve metal-sprayed epoxy molds. The internal walls of the mold used can optionally be coated with known external mold-release agents in order to improve demolding properties.

The moldings produced in the mold can generally be demolded after an operating time of from 5 to 180 seconds in the mold. Demolding is optionally followed by conditioning at a temperature of about 60 to 180° C. during a period of from 30 to 120 minutes.

The resultant, preferably sheet-like PU moldings are particularly suitable for the production of flexible automobile bumpers or of flexible bodywork elements such as doors and tailgates, wheel surrounds, and rear and front aprons of automobiles.

The examples below are intended for further explanation of the invention.

### EXAMPLES

Starting Materials

Prepolymer 1:

52.8 parts by weight of a mixture of 80% by weight of 4,4′-diisocyanatodiphenylmethane, 10% by weight of 2,4′-diisocyanatodiphenylmethane, and 10% by weight of 3-ring MDI were reacted at 90° C. with 47.2 parts by weight of polyether polyol 1.

NCO content after 2 hours: 15.4%

Polyol 1:

Polyether polyol with OH number 48 and functionality 2.8, produced via reaction of a mixture of glycerol as trifunctional starter and propylene 1,2-glycol as difunctional starter with propylene oxide/ethylene oxide in a ratio of 90:10.

Polyol 2:

Polyether polyol with OH number 28, produced via propoxylation of sorbitol as hexafunctional starter and then ethoxylation in a ratio of 83:17 with predominantly primary OH groups.

DETDA:

Mixture of 80% by weight of 1-methyl-3,5-diethyl-2,4-diaminobenzene and 20% by weight of 1-methyl-3,5-diethyl-2,6-diaminobenzene.

Jeffamin D 400:

Aliphatic diamine from Huntsman

DABCO 33 LV:

1,4-Diazabicyclo[2.2.2]octane (33% by weight in dipropylene glycol) from Air Products

Tremin 939-304:

Wollastonite from Quarzwerke Frechen

Carbon Fiber

Tenax®-A HT M100 100mu from Toho Tenax Europe GmbH (chopped length 100 μm)

Hollow Glass Microspheres:

3M™ Glass Bubbles™ iM30K from 3M

The formulations described below were processed by the reaction injection molding technique. The A component and the B component were mixed intimately in a machine-controlled mixing head in high-pressure metering equipment and then forced by way of restrictor-bar gating into a heated sheet mold measuring 300×200×3 mm, the temperature of which was 60° C.

The temperature of the A component was 65° C., and the temperature of the B component was 50° C.

The mechanical values were measured after conditioning for 30 minutes at 120° C. in a convection drying oven and then storage for 24 hours.

Before each run, the mold was treated with EWOmold 5408 mold-release agent from KVS Eckert & Woelk GmbH.

Polyol Formulation 1:

51.53% by weight of polyol 2

42.0% by weight of DETDA

2.75% by weight of Zn stearate

3.45% by weight of Jeffamin D 400

0.16% by weight of DABCO 33 LV

0.11% by weight of dimethyltin bis-2,2-dimethyloctanoate

OH number: 288.7

### Inventive Example 1

29.10 parts by weight of 3M™ Glass Bubbles™ iM30K, followed by 14.55 parts by weight of Tenax®-A HT M100 100mu, were stirred into 100 parts by weight of polyol formulation 1, and, under the processing conditions conventional for the RIM technique, this mixture was injected with 147.37 parts by weight of prepolymer 1 into a mold of dimensions 300×200×3 mm, heated to 60° C. (Index 105). The molding was demolded after 30 s.

### Comparative Example 2

33.89 parts by weight of 3M™ Glass Bubbles™ iM30K, followed by 57.61 parts by weight of Tremin 939-304, were stirred into 100 parts by weight of polyol formulation 1, and, under the processing conditions conventional for the RIM technique, this mixture was injected with 147.37 parts by weight of prepolymer 1 into a mold of dimensions 300×200×3 mm, heated to 60° C. (Index 105). The molding was demolded after 30 s.

Mechanical properties were determined as follows:

Envelope density in accordance with DIN 53 420

Flexural modulus of elasticity in accordance with ASTM 790

Tensile strength in accordance with DIN 53 504

Dynstat at −25° C. in accordance with DIN 53 435-DS (low-temperature toughness)

Flexural modulus of elasticity was in each case determined along and perpendicularly to the direction of flow/direction of fibers.

An anisotropy factor was defined as a measure of isotropy. This is the quotient calculated from the flexural modulus of elasticity along and perpendicularly to the direction of the fibers. The higher the factor, the greater the anisotropy.

TABLE 1
Mechanical properties

| | | | Longitudinal/ | | | |
|---|---|---|---|---|---|---|
| | | | transverse | | | |
| | | | flexural | | | |
| | | Envelope | modulus of | | Dynstat | Tensile |
| | Filler | density | elasticity | Anisotropy | −25° C. | strength |
| | [% by wt.] | [kg/m³] | [MPa] | factor | [kJ/m²] | [MPa] |
| Inventive | Glass Bubbles: 10 | 1030 | 1010/810 | 1.25 | 12 | 23 |
| example 1 | C fiber: 5 | | | | | |
| Comparison 2 | Glass Bubbles: 10 | 1160 | 1130/800 | 1.41 | 10 | 21 |
| | Mineral fiber: 17 | | | | | |

Inventive example 1 shows that the use of 10% by weight of hollow glass microspheres and 5% by weight of carbon fibers, based on the elastomer, achieved a flexural modulus of elasticity of 1010 MPa along the direction of the fibers and 810 MPa perpendicularly to the direction of the fibers with an envelope density of 1030 kg/m³ for the molding. If 17% by weight of mineral fibers (comparative example 2) were used instead of 5% by weight of carbon fibers, comparable flexural moduli of elasticity were achieved. However, there was an attendant increase in density of more than 10% in comparison with inventive example 1. The molding moreover exhibited markedly higher anisotropy, with a factor of 1.41, poorer low-temperature toughness, and also lower tensile strength.

A polyurethaneurea elastomer was provided which, in comparison with an elastomer produced in accordance with the prior art, has a density that is lower by more than 10%, and also markedly lower anisotropy, with comparable flexural modulus of elasticity. Low-temperature toughness and tensile strength were moreover improved. Bodywork-exterior parts made of the elastomer of the invention therefore have excellent suitability for weight saving in automobile construction. By virtue of the reduced anisotropy, the components made of the elastomer of the invention are moreover less susceptible to warpage.

1. A molding equipped with reinforcing materials and made of polyurethaneurea elastomers with from 70 to 95 mol % urea content and from 5 to 30 mol % urethane content, based in each case on mol % of an NCO equivalent, obtainable via reaction of a reaction mixture made of an
A component made of
A1) aromatic diamines which at least have an alkyl substituent in each case in an ortho-position with respect to the amino groups,
A2) an aliphatic component composed of at least one polyether polyol and/or polyester polyol which respectively has hydroxy and/or primary amino groups and which has a number-average molecular weight of from 500 to 18 000 and a functionality of from 3 to 8, and
A3) optionally catalysts and/or optionally additives,
and also of, as B component, prepolymer which comprises isocyanate groups and which derives from the reaction of
B1) a polyisocyanate component from the group consisting of polyisocyanates and polyisocyanate mixtures of the diphenylmethane category and liquefied polyisocyanates of the diphenylmethane category with
B2) at least one polyol component with a number-average molecular weight of from 500 to 18 000 and with a functionality of from 2.7 to 8 from the group consisting of polyether polyols optionally comprising organic fillers and polyester polyols optionally comprising organic fillers,
characterized in that component A and/or component B comprises hollow rigid microspheres (C) and carbon fibers (D).

2. The molding as claimed in claim 1, characterized in that the hollow rigid microspheres (C) involve hollow glass microspheres.

3. The molding as claimed in claim 1, characterized in that the average fiber lengths of the carbon fibers (D) are from 60 to 200 μm.

4. The molding as claimed in claim 1, characterized in that the average fiber lengths of the carbon fibers (D) are from 90 to 200 μm.

5. The molding as claimed in claim 1, characterized in that the average fiber lengths of the carbon fibers (D) are from 90 to 150 μm.

6. The molding as claimed in claim 1, characterized in that the density of the molding is from 0.7 to 1.1 g/cm³.

7. The molding as claimed in claim 1, characterized in that the density of the molding is from 0.8 to 1.1 g/cm³.

8. The molding as claimed in claim 1, characterized in that the density of the molding is from 0.9 to 1.1 g/cm³.

9. The molding as claimed in claim 1, characterized in that the density of the molding is from 0.9 to 1.0 g/cm³.

10. The molding as claimed in claim 1, characterized in that the flexural modulus of elasticity of the molding along the direction of the fibers is at least 600 MPa.

11. The molding as claimed in claim 1, characterized in that the flexural modulus of elasticity of the molding along the direction of the fibers is at least 700 MPa.

12. The molding as claimed in claim 1, characterized in that the flexural modulus of elasticity of the molding along the direction of the fibers is at least 800 MPa.

13. The molding as claimed in claim 1, characterized in that the flexural modulus of elasticity of the molding along the direction of the fibers is at least 900 MPa.

14. The molding as claimed in claim 1, characterized in that the flexural modulus of elasticity of the molding along the direction of the fibers is at least 1000 MPa.

15. An article which comprises the moldings as claimed in claim 1 wherein the article is used as bodywork-exterior parts, bodywork elements, flexible bumpers for automobiles, wheel surrounds, doors, tailgates, front aprons and rear aprons.
